(19) United States
(12) Patent Application Publication
(10) Pub. No.: US 2020/0100547 A1
(43) Pub. Date: Apr. 2, 2020

(54) FLYTE PATCH

(71) Applicant: DARROL RAMON LOPEZ, ELIZABETH, NJ (US)

(72) Inventor: DARROL RAMON LOPEZ, ELIZABETH, NJ (US)

(21) Appl. No.: 16/150,141

(22) Filed: Oct. 2, 2018

(51) Int. Cl. A41D 27/08; B44C 1/10

(52) U.S. Cl. CPC A41D 27/08; A41D 2300/32; B44C 1/10

(57) ABSTRACT

The Flyte Patch is a patch that made out of cotton fabric or paper laminated that covers the front of the face. The Flyte Patch comes in different shapes and sizes decorated with rhinestones around the frame and around the face of the Flyte Patch. It also has velcro attachments in the back and can also be connected on to another Flyte Patch just like itself showing a double face display of two images on each side front and back showing reversible style. The Flyte Patch goes on all type of clothing and also worn as a medallion.

The Flyte Patch is patches that come in different shapes and sizes that is velcro on and off on all Clothing, Book Bags, Medallions, Lunch Bags and many more surfaces showing a style of different images and with Rhine Stones gems surrounded around the frame and face of the Flyte Patch showing a unique look.

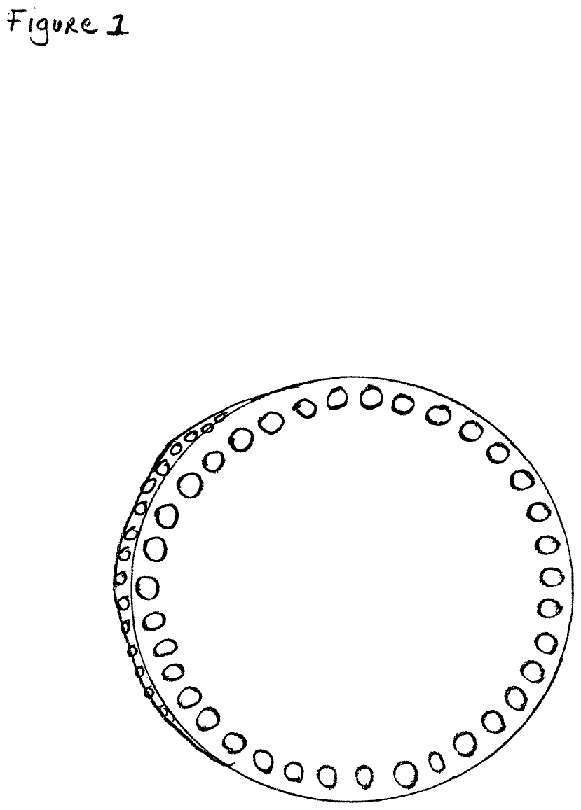

FIG. 1 This Patch is made of cotton fabric laminated with clear plastic That covers the front face and has rhinestones around the face and The outer round frame and the back is covered with velcro adhesive.

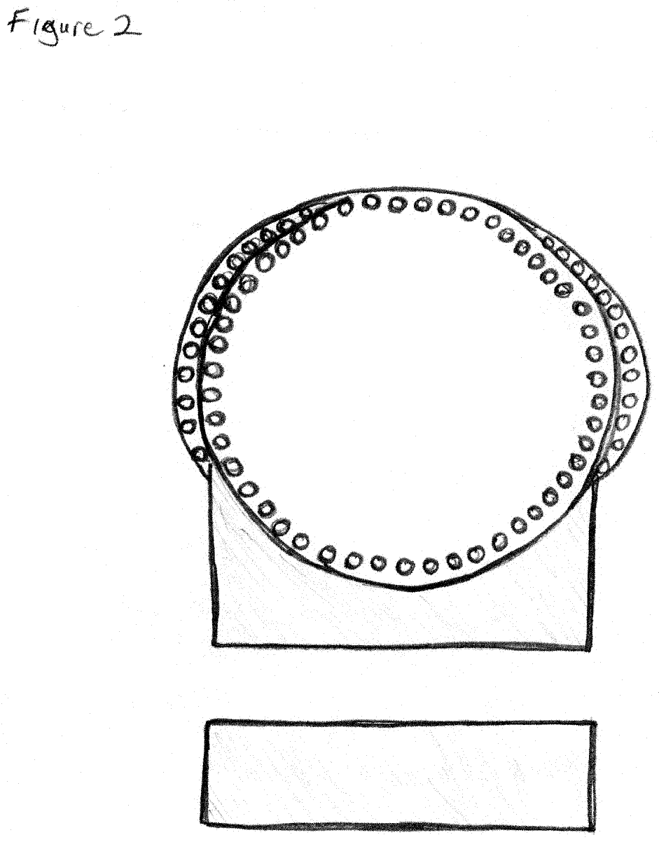

FIG. 2 This patch is a leather patch that's made to look like round ears. It has Rhinestones around the face and around the outer frame. Velcro adhesive sits at the bottom of the patch shaped like a pentagon and also has the attaching velcro stick on piece.

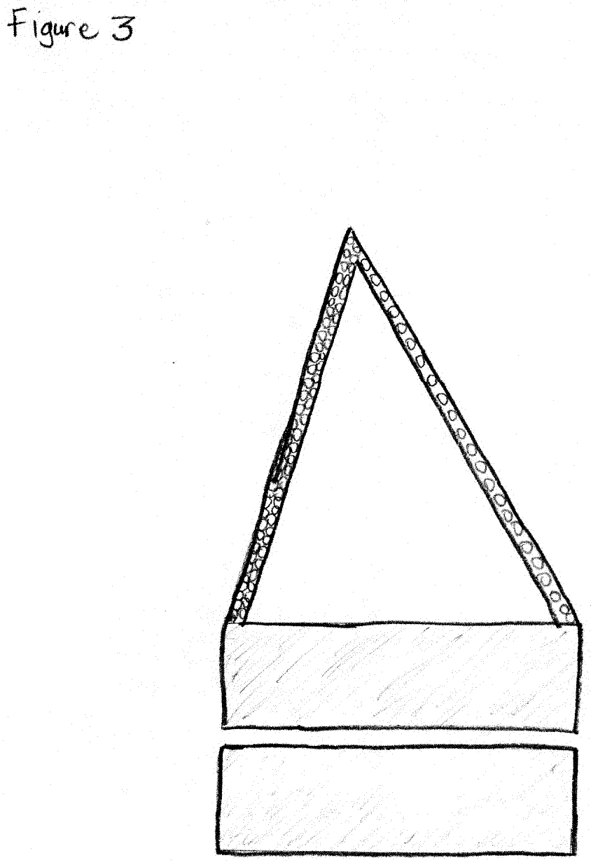

FIG. 3 This patch is a leather Triangular patch that looks like ears and is made with Rhinestones around the face and the outer frame. Velcro adhesive sits at the bottom of the patch, shaped like a pentagon and also has the attaching pentagon stock on piece

1. I claim that the flyte patch is my invention: The Flyte Patch Comes in various shapes and sizes. The Flyte Patch is attachable And is put on clothing for styling.
